(19) United States
(12) Patent Application Publication
(10) Pub. No.: US 2016/0077955 A1
(43) Pub. Date: Mar. 17, 2016

(54) REGRESSION TESTING OF RESPONSIVE USER INTERFACES

(71) Applicant: International Business Machines Corporation, Armonk, NY (US)

(72) Inventor: Santosh Werghis, Morrisville, NC (US)

(21) Appl. No.: 14/487,373

(22) Filed: Sep. 16, 2014

(51) Int. Cl. G06F 11/36; G06F 3/0481

(52) U.S. Cl. CPC G06F 11/3668; G06F 3/0481

(57) ABSTRACT

A system, method and program product are provided for testing responsive user interface logic within an application. A method is disclosed that includes: executing the application on a computing system, wherein the application includes an agent injected therein that can interact with the application and communicate with a test platform external to the application; triggering the agent to load a set of configuration parameters for a selected display system; capturing, within the agent, display attributes of an associated graphical display interface generated by the application for the selected display system; and comparing the display attributes of the associated graphical display interface with desired display attributes of the associated graphical display interface.

### TECHNICAL FIELD

The subject matter of this invention relates generally to testing the appearance of interface designs on different display types and sizes, and more specifically to a system and method for implementing regression testing of responsive user interface logic.

### BACKGROUND

Responsive user interface design, which is a generalization of responsive web design, is an approach to building user interfaces for web, desktop, mobile or other devices and channels. Responsive user interface design is aimed at automatically rendering an optimal interface for various types and sizes of display. The rendering is considered optimal when the user interface adapts fluidly to varying display sizes to provide easy reading and navigation capability with minimal panning or scrolling.

For example, an interface design for a viewable page in a mobile application may include various display elements such as widgets, icons, links, images, etc. The implementation of the interface design should be adaptable to different screen sizes (e.g., a 4″ screen versus a 4.5″ screen versus a 6″ screen) such that all of elements are properly rendered in each case. Unfortunately, automated testing to ensure such renderings are accurate remains an ongoing challenge.

While there are various frameworks, best practices and design guidelines available to create such responsive graphical display interfaces, especially for web sites, current approaches pose a challenge to automated quality testing of the graphical display interface. Current techniques address the need for quality testing using manual approaches. The graphic display interface under test is rendered on various devices or under various display sizes and subsequently visually inspected for quality. This approach has various drawbacks, including the fact that the approach is not scalable. As the number of possible channels and display sizes increase, the need for visually testing a large number of possible renderings requires significantly more human resources. This approach also fails when repeated testing (also known as regression testing) is required after any change is made to the system under test. In such cases, each cycle of regression testing requires the same manual effort, and this must be repeated many times over in common regression testing scenarios.

Further, this approach is prone to human error. Visual inspection can lead to a subjective assessment versus an objective assessment of the quality of the system under test. Different testers may have different opinions about whether or not the user interface is optimally rendered on the device or channel that is being inspected. This can also lead to inconsistent user experiences.

### SUMMARY

In general, aspects of the present invention provide a solution for performing regression testing of responsive user interface design logic within a software system (i.e., application).

A first aspect of the invention provides a method for testing an application that utilizes responsive user interface logic to generate alternative graphical display interfaces for different display systems, comprising: executing the application on a computing system, wherein the application includes an agent injected therein that can interact with the application and communicate with a test platform external to the application; triggering the agent to load a set of configuration parameters for a selected display system; capturing, within the agent, display attributes of an associated graphical display interface generated by the application for the selected display system; and comparing the display attributes of the associated graphical display interface with desired display attributes of the associated graphical display interface.

A second aspect of the invention provides a system for testing an application, wherein the application utilizes responsive user interface logic to generate alternative graphical display interfaces for different display systems, comprising: an agent configured to be injected into the application and logically interact with the application as the application is being executed on a computing system; a test platform that is external to the application, wherein the test platform communicates with the agent and triggers the agent to load a set of configuration parameters in the application for a selected display system and capture display attributes of a graphical display interface generated by the application for the selected display system; and a comparison system that compares the display attributes of the graphical display interface with desired display attributes of the graphical display interface.

A third aspect of the invention provides a computer program product stored on computer readable storage medium, which when injected into an application and executed by a processor, provides an agent to facilitate testing of responsive user interface logic implemented by the application, comprising: program code that can functionally interact with the application as the application is being executed on a computing system; program code for receiving test instructions from a test platform that is external to the application, wherein the test instructions trigger the agent to load a set of configuration parameters in the application for a selected display system; and program code for capturing display attributes of a graphical display interface generated by the application for the selected display system.

### BRIEF DESCRIPTION OF THE DRAWINGS

These and other features of this invention will be more readily understood from the following detailed description of the various aspects of the invention taken in conjunction with the accompanying drawings in which:

FIG. 1 shows a computing system having a testing system according to embodiments of the invention.

FIG. 2 shows the testing system of FIG. 1 in further detail according to embodiments of the invention.

FIG. 3 shows flow diagram of a testing process according to embodiments of the invention.

FIG. 4 shows a flow diagram for creating and capturing desired display attributes according to embodiments of the invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

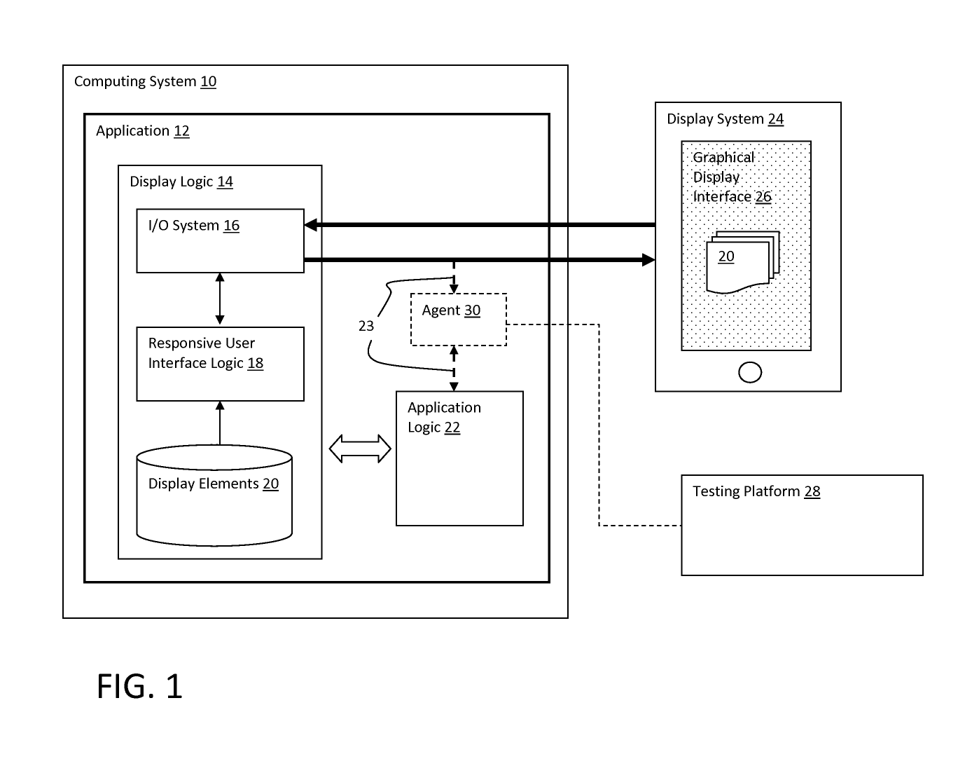

The embodiments described herein disclose a testing system and process for performing regression testing of software systems, i.e., applications, which implement responsive user interface logic. FIG. 1 depicts a computing system 10, which may comprise any computing platform capable of running an application 12 that can output a graphical display interface 26 to a display system 24. Responsive user interface logic 18 allows the graphical display interface 26 to be altered by application 12 to adhere to the display environments of an implemented or selected display system 24. In particular, depending the display system 24 being used, responsive user interface logic 18 may rearrange, resize, relocate, etc., display elements 20 that form the graphical display interface 26. Display elements 20 may comprise any features that appear within the graphical display interface 26, e.g., icons, widgets, designs, menus, colors, text boxes, banner ads, etc.

Each unique display system 24 generally includes a unique canvas size and configuration. The canvas size generally refers to a screen or window size and a configuration may include any other aspect of the display system 24 that impacts appearance, e.g., landscape versus portrait mode, operating system, browser details, etc. The appearance of display elements 20 of the graphical display interface 26 will generally differ from one display system 24 to another. Responsive user interface logic 18 thus allows a single application 12 to generate different versions of graphical display interface 26 that will be operable on different display systems 24.

Display system 24 may be integrated into the computing system or be connected externally to the computing system 10. For example, computing system 10 may comprise a smart device with an integrated display system 24, such as screen on a smart phone or tablet. Alternatively, computing system 10 may comprise a personal computer, a server, etc., that utilizes an external display system 24, such as a monitor, browser, etc. Further, computing system 10 may comprise a computing environment specifically implemented as a platform for testing display attributes of an outputted graphical display interface 26.

Shown within computing system 10 is an application 12, which when executed, includes display logic 14 for interfacing with display system 24 including displaying a graphical display interface 26 and receiving end-user responses. Application 12 may for example comprise any software system, including those that can be downloaded to a smart phone, be served and run on a client such as a browser, be served to a networked device, etc. Application 12 generally includes: (a) application logic 22 for implementing functional control, logic and operations of the application 12; and (b) display logic 14 for outputting graphical content 26 and receiving end-user responses.

As noted, application 12 may be run with different types and sizes of display systems 24, e.g., different canvas sizes, configurations, etc. Thus for example, display elements 20 may appear differently on a 4″ canvas in landscape mode versus a 6″ canvas in portrait mode. To handle this, application 12 is implemented with display logic 14 that includes responsive user interface logic 18 for generating graphical display interface 26 based on the configuration parameters of the selected display system 24. Configuration parameters may for example include encoded data that describes the size and configuration of the display system 24. An I/O system 16 within the display logic 14 may be utilized for outputting graphical display interface 26 and receiving responses.

In order to test all of the different possible rendering options, a regression test system is employed that utilizes a testing platform 28 and an agent 30. Agent 30 is embedded (i.e., injected) into the application 12 to: (1) set the configuration parameters of a target display system 24 being tested for an outputted graphical display interface 26; (2) capture the display attributes of the various display elements 20 of the graphical display interface 26; and (3) communicate with the testing platform 28 to implement various test configurations and return results.

As shown in FIG. 1, agent 30 is injected into the application 12 with “hooks” 23 to interact with the application logic 22, tap into the output of I/O system 16, and connect to testing platform 28. To achieve this, agent 30 generally comprises computer code that can be easily integrated into the application 12. The computer code can, e.g., be included in the application code itself at compile time or be linked in via a runtime library. The computer code may for example call and/or override existing routines in application logic 22 to implement configuration parameters for a selected display system 24. Based on the loaded configuration parameters, display logic 14 will generate and output display attributes specific to the selected display device 24. Agent 30 will then capture the display attributes and either evaluate them locally or pass them back to testing platform 28.

Some or all aspects of testing platform 28 may be integrated into computing system 10 or be implemented using one or more remote computing devices, e.g., via a server on a computer network.

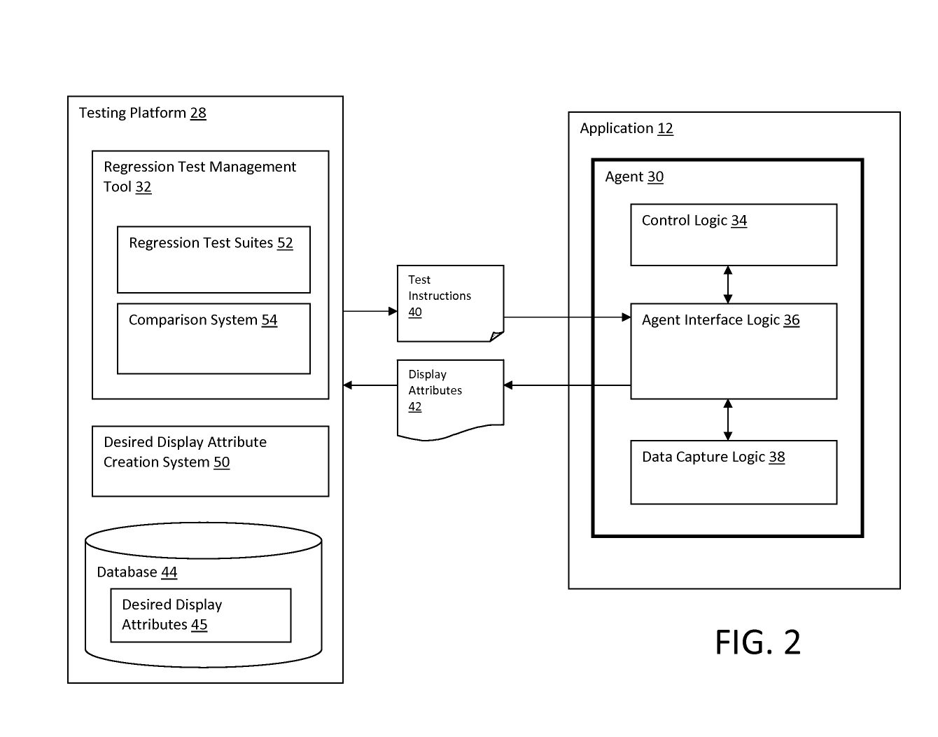

FIG. 2 depicts further details of the regression testing system and process, with reference to FIG. 1. As shown, testing platform 28 interfaces with agent 30, which is embedded in application 12. Testing platform 28 generally includes: (1) a regression test management tool 32 for controlling tests to be performed by the agent 30; (2) a desired display attribute creation system 50 for creating desired display attributes 45 of graphical display interfaces 26 for different display systems; and (3) a database 44 for storing the desired display attributes 45 and test results.

Regression test management tool 32 generally includes regression test suites 52 that allow graphical display interfaces 26 generated by the application 12 to be tested for different display systems 24. This is achieved by sending test instructions 40 to agent interface logic 36 within agent 30. Test instructions 40 may include any necessary information for triggering one or more tests from a regression test suite 52. For example, test instructions 40 may include configuration parameters (e.g., canvas size, mode, etc.) for one or more display systems 24. Once the testing is triggered, agent 30 causes control logic 34 to generate the display attributes 42 for a selected display system 24. The resulting display attributes 42 generated by the application 12 are captured by data capture logic 38 and returned back to the regression test management tool 32. A comparison system 54 may then automatically compare the collected display attributes 42 with the stored desired display attributes 45 to determine if the test is a success or failure. The comparison system 54 may utilize any routine for comparing the captured 42 versus desired 45 display elements, and, e.g., allow some margin of error for a passing test.

Display attributes 42, 45 may comprise, e.g., size, resolution, location, style, visibility and type information of all the various display elements that make up of the graphical display interface 26. For example, the desired display attributes 45 for a hypothetical graphical display interface 26 may include a widget implemented with a particular resolution, having a particular size (e.g., N×M pixels), and located at a particular location on the canvas (e.g., upper left location at P, Q pixel coordinates).

It should be understood that some aspects of the testing may be done by the agent 30. For example, the agent 30 could receive the desired display attributes 45, perform the comparison process and simply return a pass/fail.

In still a further embodiment, the captured display attributes 42 could be used to recreate an outputted image of the graphical display interface 26, which could then be manually compared to a desired graphical display interface image.

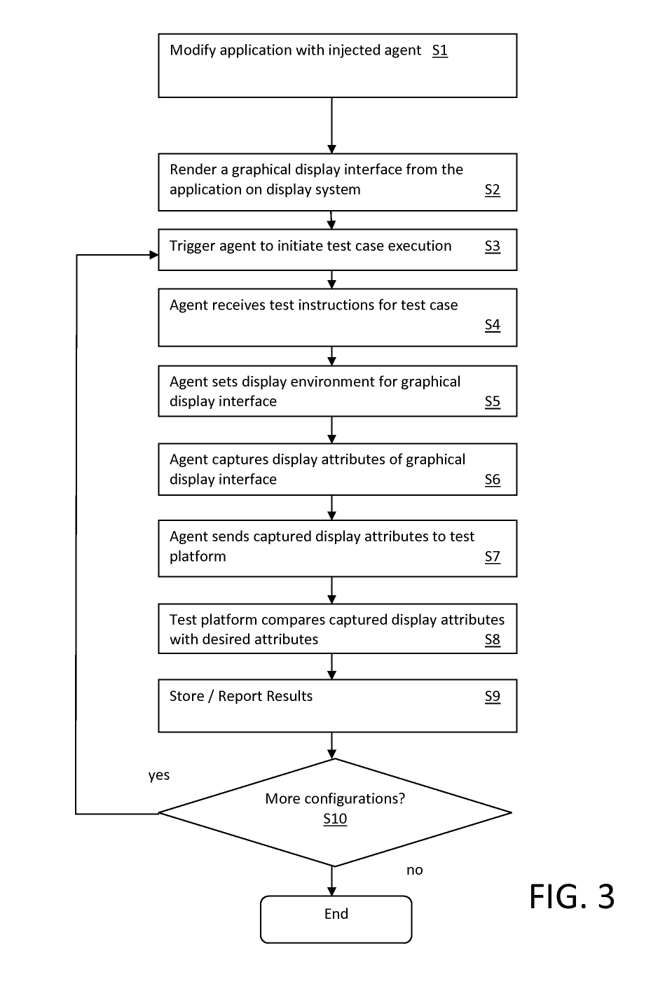

FIG. 3 depicts a flow diagram of a regression testing process, with reference to FIGS. 1 and 2. At S1, an agent 30 is injected into an application 12. One illustrative embodiment envisions the agent 30 being injected into the application 12 for each cycle of regression testing. However, other embodiments may be implemented in which the agent 30 is permanently embedded with the application 12. At S2, the application 12 is executed by the computing system 10 which renders a graphical display interface 26 of the application 12 to an attached or detached display system 24.

At S3, the agent 30 is triggered by the regression test management tool 32 to initiate the execution of a test case. The agent 30 receives test instructions (i.e., display parameters) for the display system 24 to be tested from the test platform at S4, and at S5, sets the display canvas and configuration for the graphical display interface 26 within the application 12. At S6, the agent 30 captures display attributes 42 for all elements 20 of the graphical display interface 26 as rendered under the new configuration. A variant of this embodiment would embed different configuration parameters within the agent 30, so that the agent 30 does not need to load the configuration parameters for each test case. Another variant of this implementation would transmit the configuration parameters to the agent 30 as an included trigger parameter.

The captured display attributes 42 of the display elements 20 are then sent to the test platform 28 at S7, which proceeds to compare captured display attributes 42 to previously stored desired display attributes 45 at S8. The comparison system 54 may be configured with a margin of acceptance or error for each display attribute value. If the variance between the captured display attribute value and the desired display attribute value is within the margin of acceptance, the test platform communicates a test case pass status to the regression test management tool 32 at S9. Otherwise, the test platform 28 communicates a test case failed status to the regression test management tool 32. A variant of this implementation would allow the agent 30 itself to compare the desired attribute values 45 to the captured attribute values 42. This process is continued at S10, with the agent 30 triggered to start the next test case, until all desired test cases are evaluated.

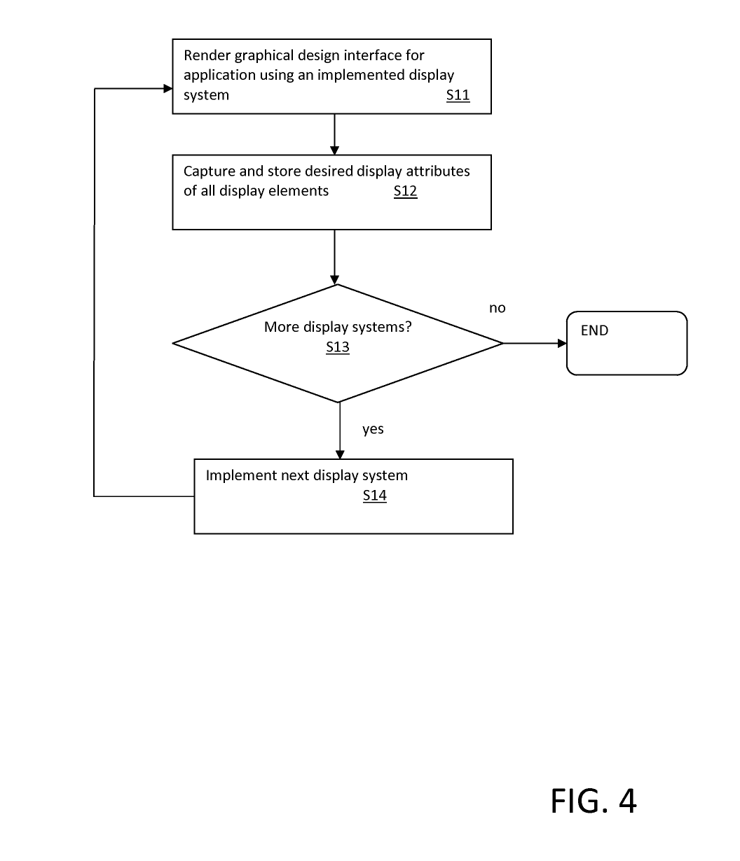

FIG. 4 depicts a flow diagram for generating desired display attributes 45 for various display systems 24 for use by a regression test suite 52. At S11, a graphical design interface 26 is rendered for an application 12 using an implemented display system 24. For example, the application 12 may be run on a smartphone having a 6″ canvas. At S12 the desired display attributes 45 for the all of the display elements 20 are captured and stored. This may for example be accomplished by interrogating the display logic output with the same agent 30 described above. At S13, a determination is made whether there are additional display systems 24 and if yes, a next display system 24 is implemented at S14. For example, the application 12 may next be loaded on a smartphone having a 4.5″ canvas. The process then repeats until all display system configurations are implemented.

The present invention may be implemented as a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Python, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

FIG. 1 depicts an illustrative computing system 10 that may comprise any type of computing device and, and for example includes at least one processor, memory, an input/output (I/O) (e.g., one or more I/O interfaces and/or devices), and a communications pathway. In general, processor(s) execute program code, such as application 12, which is at least partially fixed in memory. While executing program code, processor(s) can process data, which can result in reading and/or writing transformed data from/to memory and/or I/O for further processing. The pathway provides a communications link between each of the components in computing system 10. I/O can comprise one or more human I/O devices, which enable a user to interact with computing system 10. To this extent, application 12 can manage a set of interfaces (e.g., graphical user interfaces, application program interfaces, etc.) that enable humans and/or other systems to interact with the application 12. Further, application 12 can manage (e.g., store, retrieve, create, manipulate, organize, present, etc.) data using any solution.

For the purposes of this disclosure, the term database or knowledge base may include any system or set of systems capable of storing data including tables, data structure, XML files, etc.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A method for testing an application that utilizes responsive user interface logic to generate alternative graphical display interfaces for different display systems, comprising:
executing the application on a computing system, wherein the application includes an agent injected therein that can interact with the application and communicate with a test platform external to the application;
triggering the agent to load a set of configuration parameters for a selected display system;
capturing, within the agent, display attributes of an associated graphical display interface generated by the application for the selected display system; and
comparing the display attributes of the associated graphical display interface with desired display attributes of the associated graphical display interface.

2. The method of claim 1, wherein the configuration parameters dictate a canvas size of the display system.

3. The method of claim 1, wherein the triggering is controlled by the test platform.

4. The method of claim 1, wherein the display attributes include features selected from a group consisting of: size, resolution, location, style, visibility and type.

5. The method of claim 1, wherein the display system comprises a display device integrated into the computing system.

6. The method of claim 1, wherein the display system is external to the computing system.

7. The method of claim 1, wherein the test platform includes a regression test management tool for testing different display systems and a system for creating and storing desired display attributes.

8. A system for testing an application, wherein the application utilizes responsive user interface logic to generate alternative graphical display interfaces for different display systems, comprising:
an agent configured to be injected into the application and logically interact with the application as the application is being executed on a computing system;
a test platform that is external to the application, wherein the test platform communicates with the agent and triggers the agent to load a set of configuration parameters in the application for a selected display system and capture display attributes of a graphical display interface generated by the application for the selected display system; and
a comparison system that compares the display attributes of the graphical display interface with desired display attributes of the graphical display interface.

9. The system of claim 8, wherein the configuration parameters dictate a canvas size of the display system.

10. The system of claim 8, wherein the comparison system resides within the test platform.

11. The system of claim 8, wherein the display attributes include features selected from a group consisting of: size, resolution, location, style, visibility and type.

12. The system of claim 8, wherein the display system comprises a display device integrated into the computing system.

13. The system of claim 8, wherein the display system is external to the computing system.

14. The system of claim 8, wherein the test platform includes a regression test management tool for testing different display systems and a system for creating and storing desired display attributes.

15. A computer program product stored on computer readable storage medium, which when injected into an application and executed by a processor, provides an agent to facilitate testing of responsive user interface logic implemented by the application, comprising:
program code that can functionally interact with the application as the application is being executed on a computing system;
program code for receiving test instructions from a test platform that is external to the application, wherein the test instructions trigger the agent to load a set of configuration parameters in the application for a selected display system;
program code for capturing display attributes of a graphical display interface generated by the application for the selected display system.

16. The program product of claim 15, further comprising program code for comparing the display attributes with desired display attributes.

17. The program product of claim 15, further comprising program code for sending the display attributes to the test platform for comparison with desired display attributes.

18. The program product of claim 15, wherein the configuration parameters dictate a canvas size of the display system.

19. The program product of claim 15, wherein the display attributes include features selected from a group consisting of: size, resolution, location, style, visibility and type.

20. The program product of claim 15, wherein the configuration parameters are loaded by the agent into an application routine that controls display logic.
